(19) United States
(12) Patent Application Publication
(10) Pub. No.: US 2023/0302689 A1
(43) Pub. Date: Sep. 28, 2023

(54) WASTE PLASTIC LIQUEFACTION DEVICE AND A WASTE PLASTIC LIQUEFACTION METHOD

(71) Applicant: SHINKO TECNOS CO., LTD., Aichi (JP)

(72) Inventors: Mamoru KIMURA, Aichi (JP); Kentaro NAGASAWA, Aichi (JP)

(21) Appl. No.: 18/327,154

(22) Filed: Jun. 1, 2023

Related U.S. Application Data
(63) Continuation of application No. PCT/JP2021/043285, filed on Nov. 25, 2021.

(30) Foreign Application Priority Data
Dec. 3, 2020 (JP) 2020-200937

(51) Int. Cl. B29B 17/04

(52) U.S. Cl. CPC B29B 17/04; B29B 2017/0496; B29B 2017/0231

(57) ABSTRACT

One object is to efficiently secure good quality oil by preventing the clogging of tar in a device body or piping. There is provided a waste plastic liquefaction device comprising a pyrolysis tank that thermally decomposes and gasifies a waste plastics; a gas cooler that cools a pyrolysis gas generated in the pyrolysis tank to produce a generated oil; and a circulation tank that recovers the generated oil produced by the gas cooler and circulates a portion of the generated oil to the gas cooler. The circulation tank has a temperature adjustment device which maintains the temperature of the generated oil in the circulation tank within a predetermined temperature range in the circulation tank. The circulation tank is connected to a centrifugal separator so that the generated oil in the circulation tank is returned to the circulation tank after impurities is removed by the centrifugal separator.

### TECHNICAL FIELD

The present invention relates to a device and method for decomposing waste plastics in order to produce a recovered oil.

### BACKGROUND

In order to treat plastic products which is to be discarded and realize a recycling as a resource material, facilities have been known for thermally decomposing plastics to gasify the plastics and recovering the plastics as a liquefied oil by means of a cooling instrument.

An invention of a Patent Document 1 discloses a liquefaction facility for thermally decomposing waste plastics as raw material and converting the plastics into oil. The liquefaction facility includes a pyrolysis tank for gasifying the waste plastics and a condensation means for cooling the decomposed gas produced from the pyrolysis tank so as to generate the oil. In the Patent Document 1, the decomposed gas is cooled by spray oil in a condensation means. The oil condensed and recovered in the condensation means, is stored in the oil tank, and the oil in the oil tank is cooled to 50-80° C. by a cooler and then used as the spray oil.

A Patent Document 2 discloses an oil treatment plant provided with a dry distillation thermal decomposition device for thermally decomposing polymeric wastes such as plastic materials by means of a low-temperature dry distillation. The oil treatment plant further has a high-boiling-point oil recovery device provided with a high-boiling-point oil recovery tank and a distillation column for subjecting a pyrolysis gas generated by the dry-distillation thermal decomposition device to a temperature control, and refluxing a high-boiling-point oil with the temperature control so as to separate a low-boiling-point oil (distillate) from the high-boiling-point oil (bottom product). A low boiling point recovery device is still further provided for cooling and condensing the low boiling point oil (i.e., the distillate produced from the distillation column) to recover the low boiling point oil.

### CITATION LIST

### Patent Literature

Patent Literature 1: JP 3,836,112B
Patent Literature 2: JP-2010-222547A

### SUMMARY

### Technical Problem

However, since the oil produced in the oil tank is used as an oil shower or a spray in the condenser as it is in the liquefaction facility for converting the waste plastics into oil in the Patent Documents 1, 2, impurities such as tar and water component is also contained in the oil shower, so that the quality of the generated oil is not sufficiently high. Further, when tar is generated inside the condenser or in the piping extended from the oil tank to the oil shower nozzle, the tar would generate a clogging and need a work for maintenance. Therefore, it is desired to prevent the tar from remaining in the condenser or the piping.

In the Patent Document 1, the oil in the oil recovery tank is cooled to 50-80° C. in a cooler and used for the spray oil for the first condenser. In the Patent Document 2, the oil in the recovery tank is cooled to 80-100° C. by a heat exchanger and used for the oil shower of the distillation column. However, there is room for improvement in view of temperature control efficiency.

The present invention is made with the above problem as a background, it is an object of the invention to prevent the tar or the like from being developed in a device body or piping and to efficiently obtain a good-quality oil.

### Solution to Problem

According to the present invention, there is provided a waste plastic liquefaction device which has a pyrolysis tank that thermally decomposes and gasifies waste plastics, a gas cooler that cools the pyrolysis gas generated in the pyrolysis tank to produce a generated oil, and a circulation tank that recovers the generated oil produced by the gas cooler and circulates a portion of the generated oil to the gas cooler. The circulation tank is provided with a temperature adjustment device for maintaining temperature of the generated oil in the circulation tank within a predetermined temperature range in the circulation tank. The temperature adjustment device includes a cooling pipe attached to the circulation tank. The circulation tank is connected to a centrifugal separator, so that the generated oil in the circulation tank is returned to the circulation tank after impurities containing tar and water component is removed by means of the centrifugal separator.

The “temperature adjustment device” may be acceptable in as much as the device is capable of maintaining a predetermined temperature range, and the temperature adjustment device is not limited to a device including both the cooling mechanism and heating mechanism, but may be a device including only the cooling mechanism.

According to this configuration, since the produced oil from which water and tar are removed by the centrifugal separator is supplied to the gas cooler and is brought into direct contact with the pyrolysis gas, the quality of the produced oil is improved, and the tar clogging in the piping extended from the circulation tank to the gas cooler can be suppressed. Further, since the generated oil in the circulation tank is maintained for a predetermined time period and stirred by the action of the centrifugal separator, it becomes possible to improve the temperature control efficiency.

It is preferable that the gas cooler is provided at its upper portion with a supply port for supplying the generated oil from the circulation tank, and is provided with a plurality of stages of shelf boards each inclines downward and each has a plurality of openings. The supply port is preferably provided with a single-hole nozzle. The supply port is preferably provided with a shower nozzle having a plurality of holes each having a diameter of 5-15 mm.

According to this configuration, since the shelf boards are inclined downward, even if the tar is generated in the gas cooler, it becomes ready to flow down the tar, while at the same time, the generated oil is scattered like a shower from the opening of the shelf board in the gas cooler, so that it is possible to facilitate to flow down the tar in the lower stage of the shelf board. The shelf board provided with the opening is preferably formed by a punching plate. When the oil can be scattered out like the shower by the openings of the shelf boards, the supply port for supplying the generated oil does not need to have the shower nozzle or the like, and the clogging of tar in the nozzle can be prevented.

The temperature adjustment device is further provided with a heater attached to the circulation tank, and the temperature of the generated oil in the circulation tank is preferably kept at 60-80° C. in the circulation tank by means of the temperature adjustment device.

According to this configuration, since the pyrolysis gas is cooled at the temperature of 60-80° C., an oil having a relatively high flash point can be efficiently generated and recovered, and a gas (having oil of a relatively low flash point) which has not been liquefied into oil can be advanced to the next step.

The pyrolysis tank is detachably mounted on a heating tank. The heating tank is provided with a heated air induction fin capable of forming a spiral heat flow path of the heated air between an inner surface of the heating tank and an outer peripheral surface of the pyrolysis tank. The heating tank is provided at its lower portion with a main burner and an auxiliary burner at positions facing each other. The heated air from the main burner and the auxiliary burner is supplied in the substantially tangential direction of the heating tank, and the pyrolysis gas, which is not condensed is preferably to be a fuel for the auxiliary burner.

With this configuration described above, it is possible to efficiently heat the pyrolysis tank in the heating tank.

The pyrolysis tank has a pyrolysis tank body and a pyrolysis tank lid portion, and a reformulation catalyst layer for carrying a catalyst is preferably provided in the pyrolysis tank lid portion.

According further to the present invention, there is provided a waste plastic liquefaction method. The method includes a thermal decomposition step of pyrolyzing and gasifying waste plastics, a condensation step in which the pyrolysis gas obtained in the thermal decomposition step is cooled by a gas cooling device and a part of the pyrolysis gas is condensed to obtain a generated oil, and a recovering step for recovering the generated oil obtained in the condensation step into a circulation tank. The method further includes a step of controlling a temperature of the generated oil in the circulation tank within a predetermined temperature range in the circulation tank, as well as continuously taking out a portion of the generated oil in the circulation tank to make impurities including water and tar separated from the generated oil by a centrifugal separator and allowing the generated oil returned to the circulation tank, and a step of supplying a portion of the generated oil from the circulation tank to the gas cooling device.

### Advantageous Effects of Invention

According to the present invention, the generated oil in the circulation tank is stirred by the centrifugal separator, so that the temperature control efficiency can be improved, and the generated oil from which the tar or water component has been removed is supplied to the gas cooler, so that the quality of the product oil is improved. The tar generation in the piping extended from the circulation tank to the gas cooler is also suppressed, and even if the tar is generated in the gas cooler, it is possible to readily flow down the tar by the oil, so as to facilitate the maintenance. When the generated oil in the circulation tank is kept at 60-80° C. by the temperature adjustment device, the oil having a relatively high flash point can be generated and recovered in the gas cooler, and the gas (having oil of a relatively low flash point) which has not been converted into oil can be transferred to the next step. Further, the constitutions of the pyrolysis tank and the heating tank makes it possible to perform the thermal decomposition efficiently.

### BRIEF DESCRIPTION OF THE DRAWINGS

FIG. 1 is an explanatory diagram showing a configuration of a waste plastic liquefaction device according to a first embodiment;

FIG. 2A is a plan sectional view illustrating a heating tank according to the first embodiment;

FIG. 2B is a front cross-sectional view illustrating a heating tank according to the first embodiment;

FIG. 3A is a front cross-sectional schematic view of a gas cooler according to the first embodiment;

FIG. 3B is a left-side perspective view of a gas cooler according to the first embodiment; and

FIG. 4 is an explanatory diagram showing a configuration of a waste plastic liquefaction device according to a second embodiment.

### DESCRIPTION OF EMBODIMENTS

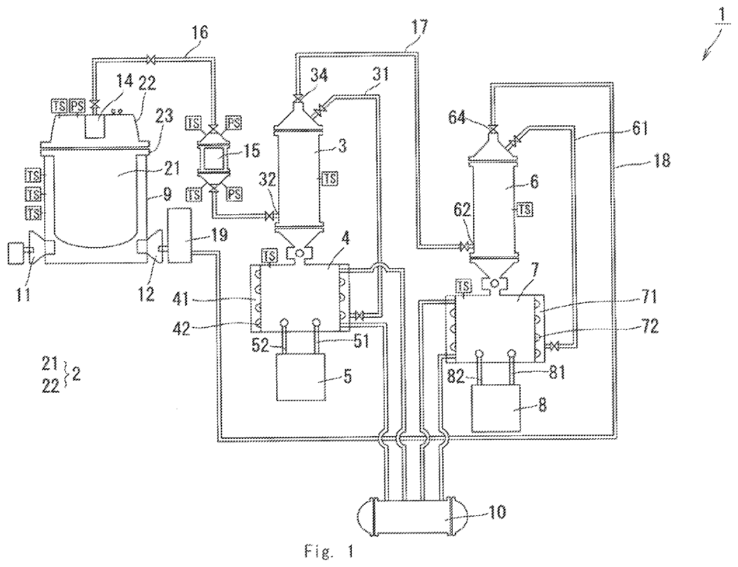

A first embodiment of a waste plastic liquefaction device according to the present invention is described in detail with reference to FIGS. 1-3.

In the waste plastic liquefaction device 1 according to the first embodiment of the present invention, a pyrolysis tank 2 is provided for heating and gasifying waste plastics as a raw material as shown in FIG. 1. A first gas cooler 3 is provided for cooling and condensing the pyrolysis gas generated in the pyrolysis tank 2. A first circulation tank 4 is provided for storing the oil generated by the first gas cooler 3 and circulating a portion of the generated oil into the first gas cooler 3. A first centrifugal separator 5 is provided for separating and removing impurities such as tar, water component, dust and sludge from the generated oil in the first circulation tank 4 and returning the generated oil to the first circulation tank 4. A second gas cooler 6 is provided for further cooling and condensing the pyrolysis gas which is not condensed in the first gas cooler 3. A second circulation tank 7 is also provided for storing the oil generated by the second gas cooler 6 and circulating a portion of the generated oil into the second gas cooler 6. A second centrifugal separator 8 is provided for separating and removing impurities such as tar, water component, dust and sludge from the generated oil in the second circulation tank 7 and returning the generated oil to the second circulation tank 7. In FIG. 1, TS represents a temperature sensor and PS represents a pressure sensor.

A first reformulation catalyst layer 14 and a second reformulation catalyst layer 15 are provided between the pyrolysis tank 2 and the first gas cooler 3. This is because it becomes necessary to neutralize the pyrolysis gas, or to further reform the pyrolysis gas so as to reduce the molecular weight depending on the kinds of the waste plastics.

The kinds of the waste plastics include polypropylene, polyester, polyethylene, ABS, polyurethane, polyvinyl chloride, FRP, etc.

The waste plastics put into the pyrolysis tank 2 is gasified through a liquefaction process in the pyrolysis tank 2 and develops into the pyrolysis gas. The pyrolysis gas flows into the first gas cooler 3 through the first reformulation catalyst layer 14, the piping 16, and the second reformulation catalyst layer 15, and the pyrolysis gas is partly condensed to be recovered in the first circulation tank 4. The pyrolysis gas which is not condensed in the first gas cooler 3 flows into a second gas cooler 6 through a piping 17, and is partly condensed to be recovered by a second circulation tank 7. The pyrolysis gas which is not condensed even in the second gas cooler 6 is transferred to an off-gas combustion device 19 via a piping 18 so as to be used as a fuel for the auxiliary burner 12.

The main device, the piping and the like of the present invention are described hereinafter in detail.

### (The Pyrolysis Tank 2 and the Heating Tank 9)

The pyrolysis tank 2 is in a cartridge type structure and internally contains the waste plastics to be thermally decomposed. The pyrolysis tank 2 has a pyrolysis tank body 21 and a pyrolysis tank lid portion 22. Since the pyrolysis tank body 21 has a wide an opening portion in an upper surface, the waste plastics can be easily put in, and its residue can be easily taken out through the opening portion. It is not necessary to finely crush the waste plastics. The pyrolysis tank 2 can be detachably arranged inside the heating tank 9, so that the pyrolysis tank 2 is to be replaced with another counterpart tank 2 after the end of the treatment. The accommodation capacity of the pyrolysis tank 2 is 0.2-5 cubic meters, and the treatment time taken by one pyrolysis tank 2 is 5-7 hours. The possible working rotations per day is 2-4 turns.

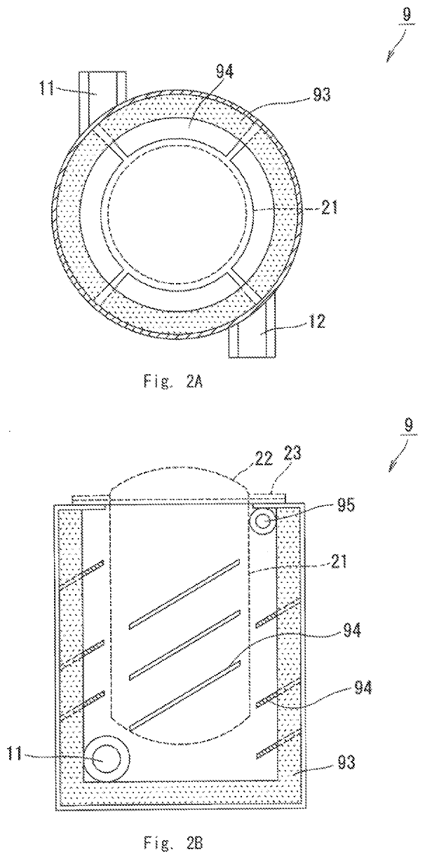

As shown in FIGS. 2A and 2B, the heating tank 9 is provided with a heat insulating layer (refractory brick) 93 on its inner peripheral side surface, and a heated air induction fin 94 which is spirally formed to define a spiral heat flow path of the heated air gas on an outer peripheral surface side of the pyrolysis tank body 21 and inside the heat insulating layer 93. Specifically, the heated air induction fin 94 is welded to an inside surface of the heating tank 9, and the inner peripheral surface of the heating tank 9 is covered with the refractory brick 93, a thickness of which is thinner than that of the heated air induction fin 94. The heated air induction fin 94 guides the heated high-temperature air from the main burner 11 and the auxiliary burner 12 to an entire inner periphery of the heating tank 9, so as to apply the heated air uniformly to the pyrolysis tank body 21 from the outside thereof. The heated air induction fin 94 needs not to form a continuous body insofar as the air induction fin 94 can guide the heated air gas, and may be divided into a plurality of pieces as observed in the present embodiment of the invention. The pyrolysis tank body 21 has a flange 23 which extends outward from an upper edge portion and is supported by an upper surface of the heating tank 9.

As shown in FIG. 2A, the main burner 11 and the auxiliary burner 12 are provided so as to inject the heated air in a substantially tangential direction in a plan view at a lower portion of the heating tank 9. The auxiliary burner 12 is provided at a position facing the main burner 11, and the heated air from the auxiliary burner 12 is arranged to be along the heated air flow from the main burner 11. The main burner 11 and the auxiliary burner 12 are installed to form 3-5 degrees upward against a horizontal plane, i.e., a bottom surface of the heating tank 9. The main burner 11 and the auxiliary burner 12 inject the heated air gas toward a space below the bottom surface of the pyrolysis tank body 21 within the heating tank 9, so that the heated air meets at the inner wall. Then, the heated air is guided by the heated air induction fin 94, and rises spirally to be released from a heated air outlet 95. The pyrolysis tank lid portion 22 is placed to close an inner space within the pyrolysis tank body 21. The thermal decomposition is carried out at 250-600° C.

To a central portion of the upper surface of the pyrolysis tank lid portion 22, connected is a pipe 16 which is led to the first gas cooler 3. The first reformulation catalyst layer 14 is provided in the vicinity of an inlet toward the piping 16 within the pyrolysis tank lid portion 22. That is, the first reformulation catalyst layer 14 is provided on a downstream side of the pyrolysis tank body 21 and on an upstream side of the piping 16. The first reformulation catalyst layer 14 contains, for example, zeolite, and further reduces the molecular weight of the decomposed gas, thereby suppressing the tar from developing in the subsequent process and improving the recovery rate of the generated oil. The first reformulation catalyst layer 14 may further contain an alkali agent such as slaked lime. Since the first reformulation catalyst layer 14 is provided in the pyrolysis tank lid portion 22, when vinyl chloride is contained in the waste plastics by way of example, it is possible to quickly neutralize a generated acidic pyrolysis gas with alkali, thereby suppressing the corrosion from being developed in the piping 16 when the acidic pyrolysis gas is brought into contact with the piping 16.

A safety device (not shown) is provided in the pyrolysis tank lid portion 22, and nitrogen gas is supplied to extinguish a blaze in case when combustion would have occurred within the pyrolysis tank 2.

The piping 16 is provided with a second reformulation catalyst layer 15. The second reformulation catalyst layer 15 contains, for example, zeolite and further reduces the molecular weight of the pyrolysis gas, thereby suppressing the tar from developing in the subsequent process so as to improve the recovery rate of the generated oil. When the first reformulation catalyst layer 14 and the second reformulation catalyst layer 15 are insufficient to work, the third reformulation catalyst layer and the fourth reformulation catalyst layer may be additionally provided. On the other hand, the first reformulation catalyst layer 14 and the second reformulation catalyst layer 15 are not required when the thermal decomposition property of the raw material is superior and a homogeneous thermal decomposition gas is obtained.

Maintaining the piping 16, the first reformulation catalyst layer 14, and the second reformulation catalyst layer 15 at a high temperature by utilizing a heating wire or the wasted heat suppresses the tar from developing in a stage before a cooling step by the first gas cooler 3. In this embodiment of the invention, the exhaust gas from the heated air outlet 95 of the heating tank 9 is utilized for maintaining the piping 16 etc. at a high temperature.

### (The First Gas Cooler 3)

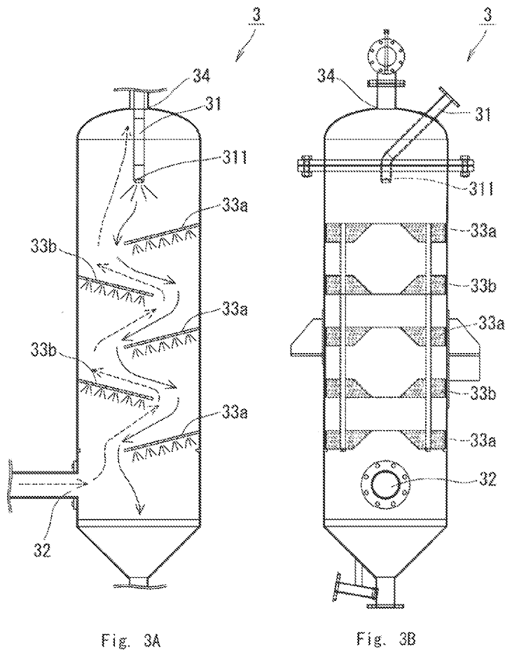

The first gas cooler 3 condenses and recovers the high flash point oil, and the low flash point oil is sent to the next process in the condition of the gas. In FIG. 3A, the solid line indicates the flow of the generated oil, and the broken line indicates the flow of the pyrolysis gas. In the first gas cooler 3, the pyrolysis gas passed through the piping 16 is supplied from a supply port 32. The supply port 32 is provided at a lower half part than a central height position of the main body of the first gas cooler 3. As shown in FIG. 3A, the pyrolysis gas rises from the supply port 32 toward a pyrolysis gas outlet 34 which is provided at an upper portion of the first gas cooler 3. On the other hand, a supply port 311 which supplies the generated oil downward, is insertedly arranged in the upper portion of the first gas cooler 3. The generated oil is maintained in a prescribed temperature range and is supplied into the first gas cooler 3 from the first circulation tank 4 (described hereinafter) through the supply port 311. In the first gas cooler 3, the generated oil falls in a shower-like manner and directly contacts with the rising pyrolysis gas to efficiently cool the pyrolysis gas. The pyrolysis gas is cooled, and a portion of the pyrolysis gas is condensed and liquefied so as to be recovered in the first circulation tank 4 at a lower portion of the first gas cooler 3. The supply port 311 may spray the generated oil downward from the plurality of holes in a shower-like manner by using a shower nozzle, however, a single hole supply port may be adopted instead of the shower nozzle having a plurality of holes.

When the shower nozzle is used as the supply port 311, the diameter of each hole thereof is preferably 5-15 mm in order to make a plurality of holes in the nozzle unlikely to clog with the tar or the like. The diameter of each hole is more preferably 8-12 mm.

When a single-hole supply port is used instead of using a shower nozzle having a plurality of holes as the supply port 311, adopting a plate having a plurality of openings, such as a punching plate as shelf boards 33a, 33b (described hereinafter) makes it possible for generated oil to hit against the shelf boards 33a, 33b and spread like a shower. Such is the configuration that problems of adhering the tar, dregs, etc., to the openings of the shower nozzle can be eliminated.

The first gas cooler 3 is made of stainless steel. As shown in FIGS. 3A and 3B, provided are the shelf boards 33a, 33b which are punching plates each inclined downward in a plurality of stages. As shown in FIG. 3A, the shelf boards 33a and 33b are alternately extended from the opposed inner wall surfaces. That is, the shelf boards 33b are arranged from one of the opposed inner wall surfaces to a height-directed clearance of the shelf boards 33a which extend from the inner wall surface. As shown in FIG. 3B, the shelf boards 33a, 33b have central portions which are notched in a trapezoidal shape. This is to make the shower fall uniformly. Due to the shelf boards 33a, 33b, the pyrolysis gas and the shower-like generated oil face each other and flow in a zigzag manner.

In this instance, the shower-like generated oil within the first gas cooler 3 not only cools the pyrolysis gas but also serves to wash out the tar or the like generated in the first gas cooler 3 and release the tar or the like to the first circulation tank 4. Since the shelf boards 33a, 33b are each inclined downward, the generated tar is easy to flow. The shelf boards 33a, 33b can employ plates without any hole, however, perforated plates such as punching plates are preferable. This is because the flowing generated oil passes through the holes of the plate, and forms the shower-like configuration again to fall toward the lower stage so as to facilitate washing down the tar.

The flow rate and pressure of the generated oil supplied from the first circulation tank 4 are adjusted by a pump (not shown) and determined and controlled by a set temperature predetermined. The flow rate and pressure are set in consideration of the tar washing effect. The generated oil may be supplied in the form of a mist or spray other than a hydraulic shower, or injection jetted from a single-hole nozzle.

### (The First Circulation Tank 4 and the First Centrifugal Separator 5)

The first circulation tank 4 is arranged below the first gas cooler 3 and recovers the generated oil produced in the first gas cooler 3. The first circulation tank 4 is provided with a temperature adjustment device 41 and maintains the generated oil at a temperature within a predetermined range. The temperature adjustment device 41 includes a heating mechanism and a cooling mechanism. In more concrete terms, provided are an electric heater (not shown) wound around the first circulation tank 4, and a cooling pipe 42 capable of circulating the cold water. When the temperature of the generated oil is determined to be lower than the predetermined range from the detection result of a temperature sensor TS which detects the temperature of the generated oil in the first circulation tank 4, the generated oil is heated by the electric heater. When the temperature of the generated oil is higher than the predetermined range, the generated oil is cooled by the cooling pipe 42. In the present embodiment, control is performed by using a PLC (programmable logic controller). The water in the cooling pipe 42 is cooled by a cooling tower 10 (described hereinafter).

In the present embodiment, the temperature of the generated oil in the first circulation tank 4 is adjusted to 60-80° C. by a temperature adjustment device 41. The pyrolysis gas flowing into the first gas cooler 3 includes a gas that transforms into an oil having a flash point of less than 60° C. and water vapor. The oil having the flash point of less than 60° C. has a limitation at its handling. In this embodiment, since the temperature of the generated oil in the first circulation tank 4 is maintained at 60-80° C., the oil having the flash point of less than 60° C. is not condensed in the first gas cooler 3 and is not recovered by the first circulation tank 4. This makes it possible to secure an extremely good quality at the generated oil in the first circulation tank 4. Since the generated oil in the first circulation tank 4 is circulated and stirred by releasing from and returning to the first centrifugal separator 5 as described hereinafter, the temperature of the generated oil is averaged and the temperature is efficiently controlled to 60-80° C.

The generated oil in the first circulation tank 4 is continuously supplied to a pipe 51 connected to the first centrifugal separator 5. The first centrifugal separator 5 separates the impurities such as the tar, water, dust, sludge, etc., from the generated oil by means of specific gravity. The generated oil from which the impurities have been removed, returns to the first circulation tank 4 via the piping 52. The first centrifugal separator 5 can remove the moisture-containing impurities from the oil in a short period of time. Repeatedly passing the oil in the first centrifugal separator 5 improves the refining degree of the oil. Stirring the generated oil in the first circulation tank 4 by releasing from and returning to the first centrifugal separator 5 resultantly makes it possible to improve an efficiency of the temperature control, and improve the quality of the generated oil in the first circulation tank 4, and further contribute to a quality improvement of the generated oil produced by the first gas cooler 3. A volume of the generated oil stored in the first circulation tank 4 and a supply flow rate to the first centrifugal separator 5 are adjusted in accordance with the scale of the waste plastic liquefaction device in order to sufficiently obtain the stirring action by the first centrifugal separator 5.

By removing the tar component by the first centrifugal separator 5, the tar content in the generated oil supplied to the supply port 311 in the first gas cooler 3 is reduced, and the tar clogging generated in the piping 31 continued to the supply port 311 is suppressed. The quality of the oil produced in the first gas cooler 3 is improved by supplying the generated oil from which moisture and impurities are removed by means of the first centrifugal separator 5 into the first gas cooler 3.

In the first circulation tank 4, a certain amount or more of the generated oil may be transferred to a high flash point oil (heavy oil) recovery device (not shown) by a level switch or the like. Otherwise, the generated oil, which passed through the first centrifugal separator 5 may be transferred to a high flash point oil (heavy oil) recovery device (not shown).

### (The Second Gas Cooler 6)

The second gas cooler 6 condenses the low flash point oil which is not condensed in the first gas cooler 3. Since the second gas cooler 6 has the same structure as that of the first gas cooler 3, the detailed explanation is omitted. A piping 17 is connected to a supply port 62, and the pyrolysis gas of the low flash point oil is supplied from the supply port 62 provided at a position lower than the central height position of the device body. In the same manner as the first gas cooler 3, at an upper portion of the second gas cooler 6, the generated oil cooled within the predetermined temperature range is supplied by a supply port provided at an upper end of the pipe 61, from the second circulation tank 7 through a pipe 61. In the same manner as an inside of the first gas cooler 3, the generated oil is scattered like a shower by a nozzle of the supply port or by the shelf boards each having the punching plate. The condensed oil which is condensed by the direct contact between the pyrolysis gas and the generated oil is recovered into the second circulation tank 7 at the lower position of the second gas cooler 6. In the second gas cooler 6, the shower of the generated oil not only cools the pyrolysis gas but also allows the tar component generated in the second gas cooler 6 to flow and release to the second circulation tank 7. The flow rate and pressure in which the generated oil is circulated and supplied, are adjusted by a pump (not shown) and controlled by the set temperature.

### (The Second Circulation Tank 7 and the Second Centrifugal Separator 8)

The second circulation tank 7 is arranged below the second gas cooler 6 and recovers the generated oil. The second circulation tank 7 has a temperature adjustment device 71 to maintain the generated oil at the temperature within the predetermined range. The temperature adjustment device 71 has only the cooling mechanism, and specifically has the cooling pipe 72 wound around the second circulation tank 7. When the temperature of the generated oil is determined to be higher than the prescribed range from the detection result of the temperature sensor TS which detects the temperature of the generated oil in the second circulation tank 7, the generated oil is cooled by the cooling pipe 72. The water in the cooling pipe 72 is cooled by a cooling tower 10 (described hereinafter). In this embodiment, the temperature of the generated oil in the second circulation tank 7 is adjusted to 5-30° C. The generated oil in the second circulation tank 7 is circulated and stirred by a second centrifugal separator 8 as described later, so that the temperature of the generated oil in the tank comes to be constant and the temperature is efficiently controlled. The volume of the product oil stored in the second circulation tank 7 and the supply flow rate to the second centrifugal separator 8 are adjusted in accordance with the scale of the waste plastic liquefaction device.

In the second circulation tank 7, a certain amount or more of the generated oil may be transferred to a low flash point oil (light oil) recovery device (not shown) by a level switch or the like, or the generated oil, a portion of which passed through the second centrifugal separator 8 may be transferred to a low flash point oil (light oil) recovery device (not shown).

The generated oil in the second circulation tank 7 is continuously supplied to a pipe 81 which is connected to the second centrifugal separator 8. The second centrifugal separator 8 separates impurities such as the tar, water, dust and sludge in the generated oil by mean of the specific gravity in the same manner as that of the first centrifugal separator 5. The generated oil from which the impurities are removed is returned to the second circulation tank 7 through the piping 82.

Since the low flash point oil stored in the second circulation tank 7 has limitation at its handling, it is mainly used for the main burner 11 in this embodiment

### (The Cooling Tower 10)

The water in the cooling pipes 42, 72 used for the cooling mechanism of the first circulation tank 4 and the second circulation tank 7, is transferred to the cooling tower 10. The cooling tower 10 is, for example, a multi-tubular heat exchanger provided to cool down the water warmed in the cooling pipes 42, 72 to the predetermined temperature range.

A waste plastic liquefaction method in the present embodiment is described below.

(1) The waste plastics, as the oil-generating material, is put into the pyrolysis tank body 21. The pyrolysis tank body 21 into which the waste plastics is put, is sealed by the pyrolysis tank lid portion 22 and installed in a heating tank 9.

(2) The main burner 11 is ignited, heated air generated in the burner chamber is introduced into a lower portion in the heating tank 9, the heated air is introduced into a spiral heat flow path formed by the heated air induction fin 94, so as to heat the pyrolysis tank body 21 by means of an external heat. With an increase of the temperature, the waste plastics in the pyrolysis tank 2 is liquefied and then gasified to produce the pyrolysis gas.

(3) The pyrolysis gas passes through the first reformulation catalyst layer 14 in the pyrolysis tank lid portion 22. In the case that the pyrolysis gas shows acidity, the pyrolysis gas is neutralized by adding an alkali agent to the first reformulation catalyst layer 14, and then is transferred to the second reformulation catalyst layer 15 so as to be further reduced in molecular weight.

(4) The pyrolysis gas flows into the first gas cooler 3 and rises therealong. The pyrolysis gas is cooled by a countercurrent contact with the shower-like scattered cooling oil (60-80° C.) flowed out from the supply port 311 downward, so as to produce the oil having the high flash point. The generated oil is recovered by the first circulation tank 4.

(5) The temperature of the generated oil in the first circulation tank 4 is maintained at 60-80° C. by means of the temperature adjusting device 41. In parallel, the generated oil in the first circulation tank 4 is continuously transferred to the first centrifugal separator 5 via a pipe 51. After the impurities including the tar, water, sludge, dust, etc., are removed, the oil returns to the first circulation tank 4 via the piping 52. The generated oil in the first circulation tank 4 is stirred by the generated oil flowing to the first centrifugal separator 5 so as to average the temperature.

(6) A portion of the generated oil in the first circulation tank 4 is used as the cooling oil which flows via the piping 31 from the supply port 311 placed at an upper part of the first gas cooler 3.

(7) The pyrolysis gas, which is not condensed in the first gas cooler 3 is released from the pyrolysis gas outlet 34 to be introduced into a second gas cooler 6 through a pipe 17. Then, the pyrolysis gas introduced into a second gas cooler 6 is cooled by the countercurrent contact with the shower-like cooling oil (5-30° C.) flowing downward from the supply port, so as to be condensed to produce the generated oil which is recovered by the second circulation tank 7. In the second circulation tank 7, the generated oil thus condensed is cooled to 5-30° C. by the temperature adjustment device 71, and impurities including the tar, water, sludge, dust, etc., are removed by a second centrifugal separator 8.

(8) The pyrolysis, gas, which is not condensed even in the second gas cooler 6 is released from the gas outlet 64, and passes through the piping 18 as the off-gas, and is to be burnt at the off-gas combustion device 19 by ignition, and is utilized for the auxiliary burner 12.

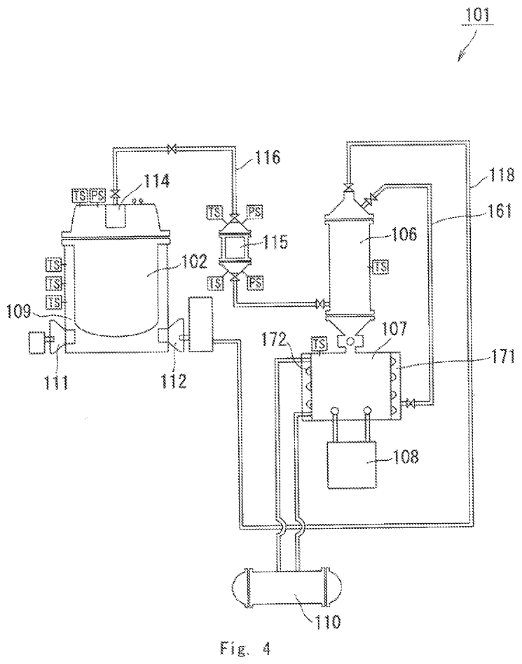

Referring now to FIG. 4, a waste plastic liquefaction device 101 according to a second embodiment of the present invention is described. Since the waste plastic liquefaction device 101 basically has a configuration similar to that of the waste plastic liquefaction device 1, the common description is incorporated into the illustration and description of the first embodiment, and the different points are described. In the numerals attached to each element, the numbers corresponding to the first embodiment is taken as 100s in the second embodiment. As opposed to the first embodiment in which the two-stage gas cooler is provided, and the high flash point oil (heavy oil) and low flash point oil (light oil) are separately produced and recovered, the second embodiment differs in that the gas cooler is in one stage, and the recovered product oil contains both the high flash point oil (heavy oil) and low flash point oil (light oil). Since the desired oil properties are different depending on the usage, whether the first embodiment or the second embodiment is selected depends on request.

In this embodiment, there are provided a gas cooler 106, a circulation tank 107 arranged under the gas cooler 106, and a centrifugal separator 108 which is circularly connected to the generated oil in the circulation tank 107 so as to remove the impurities such as the tar and water. The circulation tank 107 includes a temperature adjustment device 171 which has a cooling pipe 172 to allow the cooling water pass therethrough so as to hold the oil in the circulation tank 107 at 5-30° C. In this embodiment, the temperature of the generated oil in the circulation tank 107 is averaged and efficiently controlled by the stirring action of the centrifugal separator 108. The oil in the circulation tank 107 is supplied through a pipe 161 from a supply port placed at the upper part of the gas cooler 106. In the gas cooler 106, the generated oil is scattered out like the shower by the shower nozzle or the shelf boards each inclined downward and having a plurality of openings. In the gas cooler 106, the pyrolysis gas introduced from below is cooled and condensed by the direct contact with the generated oil supplied from the circulation tank 107. The generated oil thus condensed is in a state in which the heavy oil and light oil are mixed, and the generated oil is recovered by a circulation tank 107.

Although the preferred embodiments of the present invention have been detailed above, the present invention is not limited to the embodiments described above, and various modifications and changes are possible within the scope of the invention as set forth in the claims.

### REFERENCE SIGNS LIST

1, 101 waste plastic liquefaction device . . .
2, 102 pyrolysis tank
3 first gas cooler
4 first circulation tank
5 first centrifugal separator
6 second gas cooler
7 second circulation tank
8 second centrifugal separator
9 heating tank
10,110 cooling tower
11,111 main burner
12, 112 auxiliary burner
14, 114 first reformulation catalyst layer
15, 115 second reformulation catalyst layer
33a, 33b shelf board
41, 71,171 temperature adjusting device
42, 72,172 cooling pipe
62 supply port
21, 121 pyrolysis tank body
22, 122 pyrolysis tank lid portion
94 heated air induction fin
106 gas cooler
107 circulation tank
108 centrifugal separator
TS temperature sensor
PS pressure sensor

What is claimed is:

1. A waste plastic liquefaction device comprising:
a pyrolysis tank that thermally decomposes and gasifies waste plastics;
a gas cooler that cools a pyrolysis gas generated in the pyrolysis tank to produce a generated oil; and
a circulation tank that recovers the generated oil produced by the gas cooler and circulates a portion of the generated oil to the gas cooler,
the circulation tank being provided with a temperature adjustment device for maintaining temperature of the generated oil in the circulation tank within a predetermined temperature range in the circulation tank,
the temperature adjustment device including a cooling pipe attached to the circulation tank,
the circulation tank being connected to a centrifugal separator, so that the generated oil in the circulation tank is returned to the circulation tank after impurities including water and tar in the generated oil is removed by the centrifugal separator.

2. The waste plastic liquefaction device according to claim 1,
wherein the gas cooler comprises:
a supply port provided at an upper portion of the gas cooler for supplying the generated oil from the circulation tank, the supply port including a single-hole nozzle; and
a plurality-staged of shelf boards each of which inclines downward and having a plurality of openings.

3. The waste plastic liquefaction device according to claim 1,
wherein the gas cooler comprises:
a supply port provided at an upper portion of the gas cooler for supplying the generated oil from the circulation tank, the supply port provided with a shower nozzle having a plurality of holes each having a diameter of 5-15 mm; and
a plurality-staged of shelf boards each of which inclines downward and having a plurality of openings.

4. The waste plastic liquefaction device according to claim 1,
wherein the temperature adjustment device further includes a heater attached to said circulation tank, so that the temperature of the generated oil in the circulation tank is maintained at 60-80° C. in the circulation tank by means of the temperature adjustment device.

5. The waste plastic liquefaction device according to claim 1,
wherein the pyrolysis tank is detachably mounted on a heating tank,
the heating tank is provided with a heated air induction fin capable of forming a spiral heat flow path of the heated air between an inner surface of the heating tank and an outer peripheral surface of the pyrolysis tank,
the heating tank is provided with a main burner at a position facing each other and an auxiliary burner at a lower portion thereof, and
an entire amount of the heated air from the main burner and the auxiliary burner is supplied in the substantially tangential direction of the heating tank, and the pyrolysis gas, which is not condensed is to be a fuel for the auxiliary burner.

6. A waste plastic liquefaction method comprising:
a thermal decomposition step of pyrolyzing and gasifying waste plastics to obtain a pyrolysis gas;
a condensation step in which the pyrolysis gas obtained in the thermal decomposition step is cooled by a gas cooling device and a portion of the pyrolysis gas is condensed to obtain a generated oil,
a recovering step for recovering the generated oil obtained in the condensation step into a circulation tank,
a step of controlling a temperature of the generated oil in the circulation tank within a predetermined temperature range in the circulation tank, as well as continuously taking out a portion of the generated oil in the circulation tank to make impurities including water and tar separated from the generated oil by a centrifugal separator and allowing the generated oil returned to the circulation tank, and
a step of supplying a portion of the generated oil from the circulation tank to the gas cooling device.

7. The waste plastic liquefaction method according to claim 6 further including:
providing a supply port at an upper portion of the gas cooling device for supplying the generated oil from the circulation tank, the supply port including a single-hole nozzle; and
a plurality-staged of shelf boards each of which inclines downward and having a plurality of openings.

8. The waste plastic liquefaction method according to claim 6 further including:
providing a supply port at an upper portion of the gas cooling for supplying the generated oil from the circulation tank, wherein the supply port includes a shower nozzle having a plurality of holes each having a diameter of 5-15 mm; and
a plurality-staged of shelf boards each of which inclines downward and having a plurality of openings.

9. The waste plastic liquefaction method according to claim 6 further includes:
maintaining the temperature of the generated oil in the circulation tank at 60-80° C. in the circulation tank by means of a temperature adjustment device.

10. The waste plastic liquefaction method according to claim 6 further includes:
forming a spiral heat flow path of the heated air between an inner surface of a heating tank and an outer peripheral surface of a pyrolysis tank, and
supplying an entire amount of the heated air from main burner and an auxiliary burner in the substantially tangential direction of the heating tank, and the pyrolysis gas, which is not condensed, as a fuel for the auxiliary burner.
